(19) United States
(12) Patent Application Publication
(10) Pub. No.: US 2026/0067404 A1
(43) Pub. Date: Mar. 5, 2026

(54) Method, system and article of manufacture for validating assignment strategy in contact center system

(71) Applicant: Isbei Ltd., Grand Cayman (KY)

(72) Inventor: Abdullah Asghar Sheikh, Lahore (PK)

(73) Assignee: Isbei Ltd., Grand Cayman (KY)

(21) Appl. No.: 19/209,513

(22) Filed: May 15, 2025

(30) Foreign Application Priority Data
Sep. 2, 2024 (CN) 202411225059.0

(51) Int. Cl. H04M 3/523; G06Q 10/0639

(52) U.S. Cl. CPC H04M 3/5232; G06Q 10/0639

(57) ABSTRACT

Provided is a method for validating an assignment strategy in a contact center system, including: receiving a set of historical pairing outcomes; determining a set of training weights and a set of validation weights; assigning each record from the set of historical pairing outcomes a training weight from the set of training weights and a validation weight from the set of validation weights; determining a set of training weighted outcomes based on the set of historical pairing outcomes and the set of training weights; determining a set of validation weighted outcomes based on the set of historical pairing outcomes and the set of validation weight; determining one or more assignment strategies based on the set of training weighted outcomes; calculating expected performances for the one or more assignment strategies based on the set of validation weighted outcomes; and selecting an assignment strategy based on the expected performances.

### TECHNICAL FIELD

This disclosure generally relates to validating an assignment strategy, and, more particularly, to techniques for validating an assignment strategy in a contact center system.

### BACKGROUND

A contact center system is a system for receiving or transmitting a large number of contacts such as voice telephone calls, Internet text chats, e-mails, and video calls etc. Contact centers may include an outbound contact center that transmits outgoing contacts and/or an inbound contact center that receives incoming contacts. Outbound contact centers are often used to sell products, collect outstanding credit balances, or to survey consumer sentiment, among other applications. Inbound contact centers are also used to sell or cross-sell products, to service customer support or technical support enquiries, to retain customers, upgrade and downgrade services, or in other applications.

Various assignment strategies may be used to pair agents with contacts in a call center. In some traditional contact centers, contacts are assigned to agents sequentially, according to either a contact's arrival time or the time at which an agent becomes available. Such a strategy may be referred to as the first-in-first-out (“FIFO”) strategy. For example, if multiple agents are available to receive a contact, a FIFO strategy will assign an incoming contact to the longest waiting agent. Similarly, if multiple contacts are waiting for an assignment, a FIFO strategy will assign the longest waiting contact to the first available agent. However, FIFO only seeks to balance the waiting time of agents or contacts, and may not be aligned with other contact center metrics such as revenue generation, customer satisfaction improvement, or cost reduction.

To optimize such other contact center metrics, some contact centers adopt alternative agent-contact assignment strategies. One such example is the performance-based-routing (“PBR”) strategy. In a PBR strategy, when there are multiple agents available to receive a contact, an incoming contact will be assigned to the agent with the highest historical performance compared to other available agents. Similarly, if all agents are occupied and many contacts have been waiting for assignment, a PBR strategy assigns the contact it determines to be of the highest expected value (highest potential to make a sale) to whichever agent first becomes available.

Another example is the behavioral pairing (“BP”) strategy. BP strategies generally seek to balance utilization of agents and waiting time of contacts while still delivering improvement in contact center metrics relative to a FIFO strategy. In a BP strategy, contacts and agents are paired so that the total overall expected value over all agent and contact pairings is optimized.

BP strategies are generally built using machine learning techniques and data from historical interactions between agents and contacts. Since inevitably there will be some randomness involved with output from models built with machine learning techniques, it is necessary to validate the quality of such models. The process of finalizing a BP strategy may involve multiple iterations of “training” (creating) a candidate model, validating the model, and discarding models that do not validate well. Model training processes historical data to establish a candidate BP model. Model validation processes the same or different historical data to estimate the performance of the candidate BP model. Multiple candidate models may be trained and validated, allowing for comparison between the estimated performance of those candidate models, and the selection of a preferred model for contact center use.

There are different model validation techniques. In-sample validation is a validation technique that uses the same data for both model training and validation. In-sample validations may lead to incorrect validation results. For example, in-sample validation may be unable to detect overfitting, a scenario where a small number of data samples overly influence the model parameters.

Overfitting is especially prevalent when there is limited data. Representative historical data in a contact center environment is oftentimes a scarce resource. Representative data is data that accurately represents the characteristics of agent and contact behavior. Changing marketing campaigns, product offerings, agent population and compensation, contact behavior and a variety of other factors may all restrict the amount of representative data. For the purpose of model training and validation, the ideal approach is to use the most recent representative data. However, there oftentimes arises a need to balance the trade-off between data recentness and data availability. Accordingly, there is a need to use the representative data efficiently.

One solution to detect overfitting is by splitting the historical data into separate sets, to be used for training and validation, respectively. This is referred to as an out-of-sample validation. For example, U.S. Pat. No. 10,122,860 teaches that a single set of historical data may be split into a first subset (i.e., training set), and a holdout subset (i.e., validation set) with no overlap with the first subset, with the training set used for model training, and the holdout subset used for model validation.

In this patent, we disclose a methodology for an in-sample validation that can detect overfit models.

### SUMMARY

An embodiment of the present disclosure provides a method for validating an assignment strategy in a contact center system, including: receiving a set of historical pairing outcomes; determining a set of training weights and a set of validation weights; assigning each record from the set of historical pairing outcomes a training weight from the set of training weights and a validation weight from the set of validation weights; determining a set of training weighted outcomes based on the set of historical pairing outcomes and the set of training weights; determining a set of validation weighted outcomes based on the set of historical pairing outcomes and the set of validation weights; determining one or more assignment strategies based on the set of training weighted outcomes; calculating expected performances for the one or more assignment strategies based on the set of validation weighted outcomes; and selecting an assignment strategy based on the expected performances.

Optionally, the above method further includes: pairing an agent with a contact based on the selected assignment strategy.

Optionally, in the above method, a training weight from the set of training weights ranges from 0 to 1, and a validation weight from the set of validation weights ranges from 0 to 1.

Optionally, in the above method, a sum of a training weight and a validation weight for each historical pairing outcome is either 0 or 1.

Optionally, in the above method, the training weight and the validation weight have an inverse correspondence.

Optionally, the above method further includes: receiving a first set of records from a contact record system; receiving a second set of outcome records from a customer record system; and assigning the second set of outcome records to the first set of records based on the first set of records and the second set of outcome records.

Optionally, the above method further includes: adjusting the selected pairing strategy based on real-time conditions in the contact center system.

In embodiment of the present disclosure also provides a system for validating an assignment strategy in a contact center system, including: at least one computer processor connected to an assignment module configured to perform validating operations in the contact center system, in which the at least one computer processor is further configured to: receive a set of historical pairing outcomes; determine a set of training weights and a set of validation weights; assign each record from the set of historical pairing outcomes a training weight from the set of training weights and a validation weight from the set of validation weights; determine a set of training weighted outcomes based on the set of historical pairing outcomes and the set of training weights; determine a set of validation weighted outcomes based on the set of historical pairing outcomes and the set of validation weights; determine one or more assignment strategies based on the set of training weighted outcomes; calculate expected performances for the one or more assignment strategies based on the set of validation weighted outcomes, and select an assignment strategy based on the expected performances.

Optionally, in the above system, the at least one computer processor is further configured to: pair an agent with a contact based on the selected assignment strategy.

Optionally, in the above system, a training weight from the set of training weights ranges from 0 to 1, and a validation weight from the set of validation weights ranges from 0 to 1.

Optionally, in the above system, a sum of a training weight and a validation weight for each historical pairing outcome is either 0 or 1.

Optionally, in the above system, the training weight and the validation weight have an inverse correspondence.

Optionally, in the above system, the at least one computer processor is further configured to: receive a first set of records from a contact record system; receive a second set of outcome records from a customer record system; and assign the second set of outcome records to the first set of records based on the first set of records and the second set of outcome records.

Optionally, in the above system, the at least one computer processor is further configured to: adjust the selected pairing strategy based on real-time conditions in the contact center system.

An embodiment of the present disclosure further provides an article of manufacture for validating an assignment strategy in a contact center system, including: a non-transitory processor readable medium, and instructions stored on the medium, in which the instructions are configured to be readable from the medium by at least one computer processor connected to an assignment module configured to perform validating operations in the contact center system, and thereby cause the at least one computer processor to operate so as to: receive a set of historical pairing outcomes; determine a set of training weights and a set of validation weights; assign each record from the set of historical pairing outcomes a training weight from the set of training weights and a validation weight from the set of validation weights; determine a set of training weighted outcomes based on the set of historical pairing outcomes and the set of training weights; determine a set of validation weighted outcomes based on the set of historical pairing outcomes and the set of validation weights; determine one or more assignment strategies based on the set of training weighted outcomes; calculate expected performances for the one or more assignment strategies based on the set of validation weighted outcomes; and select an assignment strategy based on the expected performances.

Optionally, in the above article of manufacture, the at least one computer processor is further caused to operate so as to: pair an agent with a contact based on the selected assignment strategy.

Optionally, in the above article of manufacture, a training weight from the set of training weights ranges from 0 to 1, and a validation weight from the set of validation weights ranges from 0 to 1.

Optionally, in the above article of manufacture, a sum of a training weight and a validation weight for each historical pairing outcome is either 0 or 1.

Optionally, in the above article of manufacture, the training weight and the validation weight have an inverse correspondence.

Optionally, in the above article of manufacture, the at least one computer processor is further configured to: receive a first set of records from a contact record system; receive a second set of outcome records from a customer record system; and assign the second set of outcome records to the first set of records based on the first set of records and the second set of outcome records.

Optionally, in the above article of manufacture, the at least one computer processor is further caused to operate so as to: adjust the selected pairing strategy based on real-time conditions in the contact center system.

### BRIEF DESCRIPTION OF THE DRAWINGS

FIG. 1 is a schematic view showing a contact center system according to an embodiment of the present disclosure.

FIG. 2 is a schematic view showing an assignment module according to an embodiment of the present disclosure.

FIG. 3 is a flow diagram showing a method for validating an assignment strategy in a contact center system according to an embodiment of the present disclosure.

FIG. 4 is a schematic view showing an example for validating an assignment strategy in a contact center system according to an embodiment of the present disclosure.

FIG. 5, FIG. 6 and FIG. 7 are schematic views showing diagrams for train weights and validation weights according to embodiments of the present disclosure.

### DETAILED DESCRIPTION

In order to illustrate the technical solutions of the present disclosure in a coherent manner, the drawings desired for the embodiments of the present disclosure will be described briefly hereinafter. Obviously, the following drawings merely relate to some embodiments of the present disclosure. Based on these drawings, a person skilled in the art may obtain the other embodiments without any creative effort.

As used herein, the term “module” can be understood as referring to computing software, firmware, hardware and/or various combinations thereof, which can be configured as network elements, computers and/or components of systems. Modules should not be interpreted as software not implemented on hardware or firmware, or recorded on processor-readable storage media. These modules can be combined, integrated, separated and/or replicated to support various applications. The modules can be implemented on multiple devices and/or other components, which can be local or remote. In addition, these modules can be removed from one device and added to another device, and/or can be included in two devices.

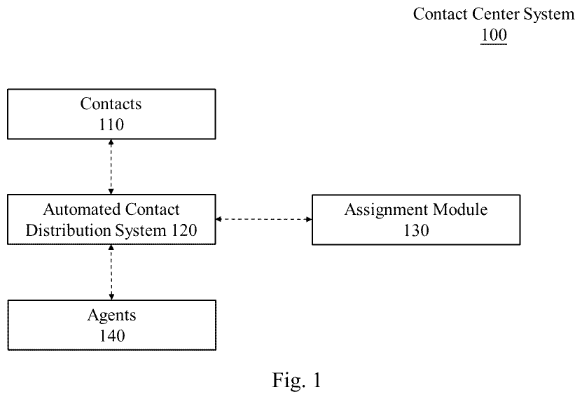

FIG. 1 is a schematic view showing a contact center system according to embodiments of the present disclosure and shows an example of a contact center system 100, which may include: an automated contact distribution (“ACD”) system 120, an assignment module 130; and agents 140.

The ACD system 120 may be configured to receive incoming contacts 110, or support outbound connections to contacts via a telecommunication network. The ACD system may include contact routing hardware and software for helping to route contacts in one or more contact centers. The ACD system may also include queuing or switching components within the contact center system 100.

The assignment module 130 is connected to the ACD system 120, and is configured to pair contacts to agents based on assignment strategies.

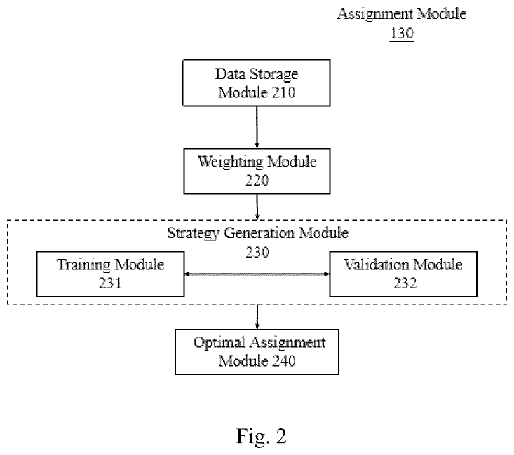

FIG. 2 is a schematic view showing an assignment module according to embodiments of the present disclosure. The assignment module 130 may also include a data storage module 210, a weighting module 220, a strategy generation module 230, and an optimal assignment module 240, in which the strategy generation module 230 includes a training module 231 and a validation module 232.

The data storage module 210 may be configured for functions such as monitoring, receiving, storing, retrieving, and outputting historical pairing information between contacts and agents. Each record of a pairing may, for example, include an agent identifier, a contact identifier, and a performance indicator (i.e., historical pairing outcome).

The weighting module 220 may be configured to: determine a set of training weights and a set of validation weights, in which the training weights and the validation weights may or may not be related to each other; assign the training weights and validation weights to historical pairing outcomes; and determine a set of training weighted outcomes and a set of validation weighted outcomes, respectively.

The strategy generation module 230 may be configured to: determine one or more assignment strategies based on the set of training weighted outcomes; calculate expected performances for the one or more assignment strategies based on the set of validation weighted outcomes; and select an assignment strategy based on the expected performances. To achieve the above, the strategy generation module 230 may include a training module 231 and a validation module 232.

The training module 231 may be configured to determine one or more assignment strategies based on the set of training weighted outcomes. Then, the one or more assignment strategies may be applied in the validation module 232.

The validation module 232 may be configured to calculate expected performances for the one or more assignment strategies based on the set of validation weighted outcomes. Based on the expected performances, the strategy generation module 230 may select an optimal assignment strategy from the one or more assignment strategies.

The optimal assignment module 240 may be configured to receive the optimal assignment strategy from the strategy generation module 230 and communicate with the ACD system 120 optimal contact-agent pairings according to the optimal assignment strategy.

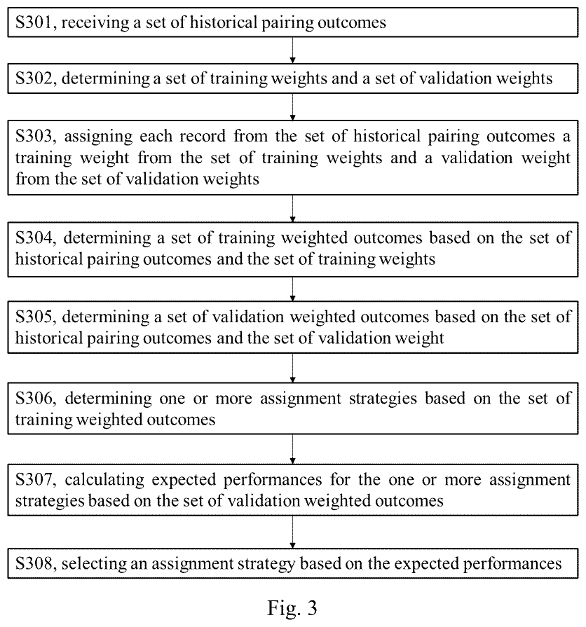

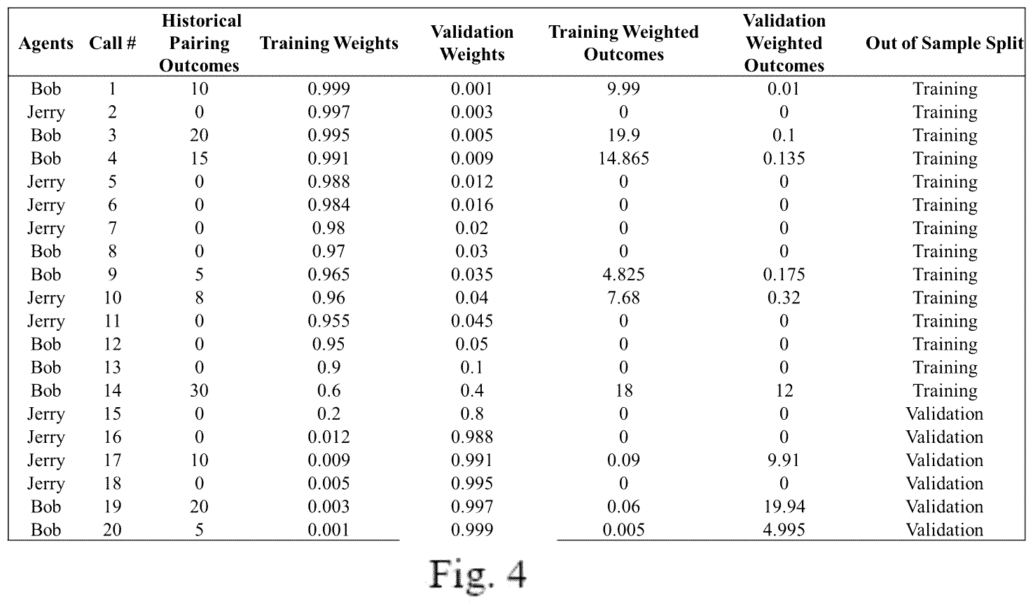

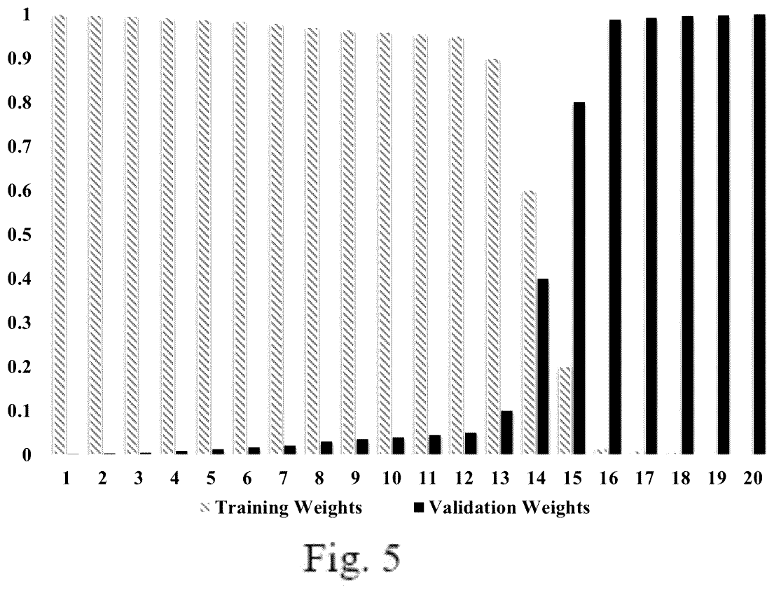

FIG. 3 is a flow diagram showing a method for validating an assignment strategy in a contact center system according to embodiments of the present disclosure. The method of present disclosure may include: S301, receiving a set of historical pairing outcomes; S302, determining a set of training weights and a set of validation weights; S303, assigning each record from the set of historical pairing outcomes a training weight from the set of training weights and a validation weight from the set of validation weights; S304, determining a set of training weighted outcomes based on the set of historical pairing outcomes and the set of training weights; S305, determining a set of validation weighted outcomes based on the set of historical pairing outcomes and the set of validation weight; S306, determining one or more assignment strategies based on the set of training weighted outcomes; S307, calculating expected performances for the one or more assignment strategies based on the set of validation weighted outcomes; and S308, selecting an assignment strategy based on the expected performances.

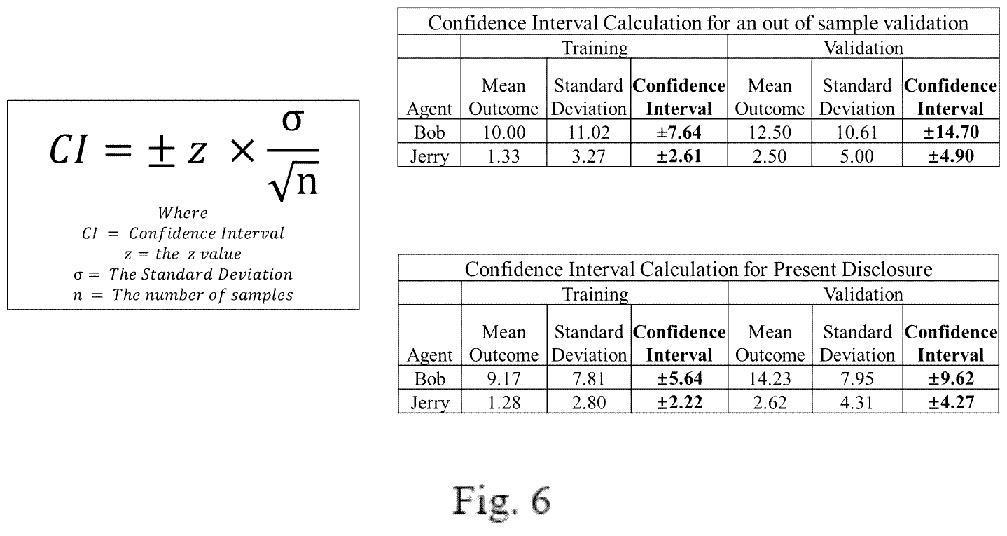

FIG. 4 is a view showing an example for validating an assignment strategy in a contact center system according to embodiments of the present disclosure. As shown in FIG. 4, a set of historical pairing data, including 20 contacts and 20 corresponding outcomes (“O”) was received, in which Contact 1 was paired to Agent Bob and brought an outcome of $10, Contact 2 was paired to Agent Jerry and brought an outcome of $0, Contact 3 was paired to Agent Bob and brought an outcome of $20, . . . , and Contact 20 was paired to Agent Bob and brought outcome of $5.

A set of training weights (“TW”) and a set of validation weights (“VW”) were determined and assigned to the set of historical pairing outcomes, to produce a set of training weighted outcomes (“TWO”) and a set validation weighted outcomes (“VWO”). As shown in FIG. 4, Contact 1 was assigned with a training weight of 0.999 and a validation weight of 0.001, Contact 2 was assigned with a training weight of 0.997 and a validation weight of 0.003, Contact 3 was assigned with a training weight of 0.995 and a validation weight of 0.005, . . . , and Contact 20 was assigned with a train weight of 0.001 and a validation weight of 0.999.

After the assignment and determining of weights, a set of training weighted outcomes was determined based on the set of historical pairing outcomes and the set of training weight. Contact 1, paired to Agent Bob, was determined to have a training weighted outcome of $9.99 (calculated from $10*0.999); Contact 2, paired to Agent Jerry, was determined to have a training weighted outcome of $0 (calculated from $0*0.997); Contact 3, paired to Agent Bob, was determined to have a training weighted outcome of $19.9 (calculated from $20*0.995); . . . ; and Contact 20, paired to Agent Bob, was determined to have a training weighted outcome of $0.005 (calculated from $5*0.001). A set of validation weighted outcomes was determined based on the set of historical pairing outcomes and the set of validation weight. Contact 1, paired to Agent Bob, was determined to have a validation weighted outcome of $0.01 (calculated from $10*0.001); Contact 2, paired to Agent Jerry, was determined to have a validation weighted outcome of $0 (calculated from $0*0.003); Contact 3, paired to Agent Bob, was determined to have a validation weighted outcome of $0.1 (calculated from $20*0.005); . . . ; and Contact 20, paired to Agent Bob, was determined to have a validation weighted outcome of $4.995 (calculated from $5*0.999).

The training weighted outcomes are used by the Training Module 231 to generate the candidate BP model(s) and the validation weighted outcomes are used by the Validation Module 232 to calculate the expected performance of the candidate BP model(s).

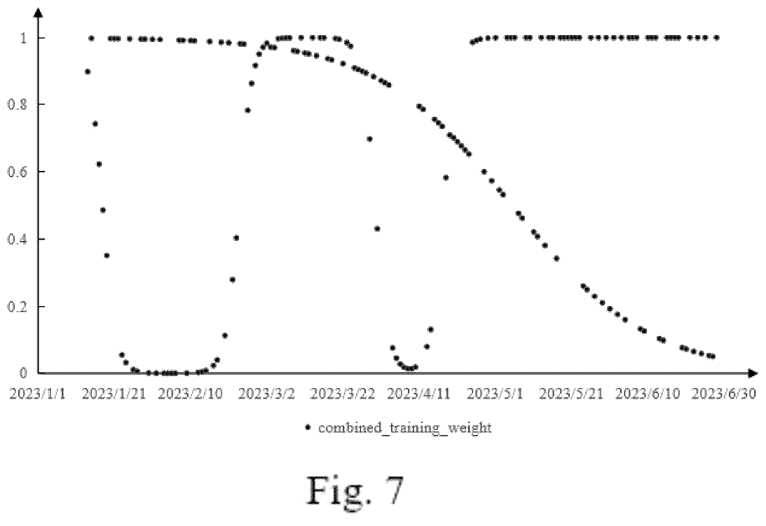

FIG. 5, FIG. 6 and FIG. 7 are schematic views showing diagrams for train weights and validation weights according to embodiments of the present disclosure.

A popular method for splitting data into train and test sets for an out-of-sample validation is to split the data by recentness. The most recent historical data is held out for validation while the remaining data is used for training. This emulates real world conditions where models generated on past data is used in the future. FIG. 5 shows how this idea may be applied in an embodiment of the present disclosure. The training and validation weights are assigned such that newer samples have a higher validation weight and lower training weight. The weights are generated by applying a sigmoid function to an adjusted timestamp of the contact, such that both the training weight and validation weight are bound between 0 and 1.

Another popular method of splitting data into training and test sets is called k-fold validation. In an out-of-sample k-fold validation, the data is split into “k” groups where a subset of the k groups are selected for training and the remaining for validation. Chronologically adjacent samples are likely to belong in the same group similar to a time validation. This has the added benefit of having the ability to run multiple validations of the same model (by changing which groups belong to the training vs validation set), thereby improving the statistical accuracy of the validation results.

FIG. 6 shows how the idea of k-folds may be used as an embodiment of the present disclosure. We select k=10 folds: numbered 1-10 with 1 being the least recent and 10 being the most recent. We randomly select folds 2, 3 and 6 to be primarily used for validation and 1, 4, 5, 7, 8, 9, and 10 to be primarily used for model training. The training and validation wights may be generated by using a linear combination of multiple sigmoid functions.

For example, the weights in figure in FIG. 6 may be generated by: adding a sigmoid function centered on 2023 Jan. 28, subtracting a sigmoid function centered on 2023 Feb. 23; adding a sigmoid function centered on 2023 Apr. 1; and subtracting a sigmoid function centered on 2023 Apr. 18.

FIG. 7 shows the training weight generated using an embodiment of the present disclosure that combines the time-based method of calculating training and validation weights and the k-fold based method of calculating training and validation weights. First, the weights are calculated using the time-based validation (as described in FIG. 5) and k-fold-based validation (as described in FIG. 6). For each sample, a random selection is made on whether to use the weight from the time-based validation or the weight from the k-fold based validation. From FIG. 7 it is evident that characteristics from both the time and k-fold based validations remain present in the combined weights.

A seasoned practitioner will validate multiple models and select an optimal model (according to the validation results). This optimal model will then be trained on the whole dataset (without the training and validation weights) and will be used to make live pairing decisions.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for validating an assignment strategy in a contact center system, comprising:
receiving a set of historical pairing outcomes;
determining a set of training weights and a set of validation weights;
assigning each record from the set of historical pairing outcomes a training weight from the set of training weights and a validation weight from the set of validation weights;
determining a set of training weighted outcomes based on the set of historical pairing outcomes and the set of training weights;
determining a set of validation weighted outcomes based on the set of historical pairing outcomes and the set of validation weight;
determining one or more assignment strategies based on the set of training weighted outcomes;
calculating expected performances for the one or more assignment strategies based on the set of validation weighted outcomes; and
selecting an assignment strategy based on the expected performances.

2. The method of claim 1, further comprising: pairing an agent with a contact based on the selected assignment strategy.

3. The method of claim 1, wherein a training weight from the set of training weights ranges from 0 to 1, and a validation weight from the set of validation weights ranges from 0 to 1.

4. The method of claim 1, wherein a sum of a training weight and a validation weight for each historical pairing outcome is either 0 or 1.

5. The method of claim 1, wherein the training weight and the validation weight have an inverse correspondence.

6. The method of claim 1, wherein the set of training weights and the set of validation weights are determined based on the combination of two or more weight-generation strategies.

7. The method of claim 1, wherein the receiving the set of historical pairing outcomes comprises:
receiving a first set of records from a contact record system;
receiving a second set of outcome records from a customer record system; and
assigning the second set of outcome records to the first set of records based on the first set of records and the second set of outcome records.

8. The method of claim 1, further comprising:
adjusting the selected pairing strategy based on real-time conditions in the contact center system.

9. A system for validating an assignment strategy in a contact center system, comprising:
at least one computer processor connected to an assignment module configured to perform validating operations in the contact center system, wherein the at least one computer processor is further configured to:
receive a set of historical pairing outcomes;
determine a set of training weights and a set of validation weights;
assign each record from the set of historical pairing outcomes a training weight from the set of training weights and a validation weight from the set of validation weights;
determine a set of training weighted outcomes based on the set of historical pairing outcomes and the set of training weights;
determine a set of validation weighted outcomes based on the set of historical pairing outcomes and the set of validation weights;
determine one or more assignment strategies based on the set of training weighted outcomes;
calculate expected performances for the one or more assignment strategies based on the set of validation weighted outcomes, and
select an assignment strategy based on the expected performances.

10. The system of claim 9, wherein the at least one computer processor is further configured to:
pair an agent with a contact based on the selected assignment strategy.

11. The system of claim 9, wherein a training weight from the set of training weights ranges from 0 to 1, and a validation weight from the set of validation weights ranges from 0 to 1.

12. The system of claim 9, wherein a sum of a training weight and a validation weight for each historical pairing outcome is either 0 or 1.

13. The system of claim 9, wherein the training weight and the validation weight have an inverse correspondence.

14. The system of claim 9, wherein the at least one computer processor is further configured to:
receive a first set of records from a contact record system;
receive a second set of outcome records from a customer record system; and
assign the second set of outcome records to the first set of records based on the first set of records and the second set of outcome records.

15. The system of claim 9, wherein the at least one computer processor is further configured to:
adjust the selected pairing strategy based on real-time conditions in the contact center system.

16. An article of manufacture for validating an assignment strategy in a contact center system, comprising:
a non-transitory processor readable medium, and
instructions stored on the medium,
wherein the instructions are configured to be readable from the medium by at least one computer processor connected to an assignment module configured to perform validating operations in the contact center system, and thereby cause the at least one computer processor to operate so as to:
receive a set of historical pairing outcomes;
determine a set of training weights and a set of validation weights;
assign each record from the set of historical pairing outcomes a training weight from the set of training weights and a validation weight from the set of validation weights;
determine a set of training weighted outcomes based on the set of historical pairing outcomes and the set of training weights;
determine a set of validation weighted outcomes based on the set of historical pairing outcomes and the set of validation weight;
determine one or more assignment strategies based on the set of training weighted outcomes;
calculate expected performances for the one or more assignment strategies based on the set of validation weighted outcomes; and
select an assignment strategy based on the expected performances.

17. The article of manufacture of claim 16, wherein the at least one computer processor is further caused to operate so as to:
pair an agent with a contact based on the selected assignment strategy.

18. The article of manufacture of claim 16, wherein a training weight from the set of training weights ranges from 0 to 1, and a validation weight from the set of validation weights ranges from to 1.

19. The article of manufacture of claim 16, wherein a sum of a training weight and a validation weight for each historical pairing outcome is either 0 or 1.

20. The article of manufacture of claim 16, wherein the training weight and the validation weight have an inverse correspondence.

21. The article of manufacture of claim 16, wherein the at least one computer processor is further configured to:
receive a first set of records from a contact record system;
receive a second set of outcome records from a customer record system; and
assign the second set of outcome records to the first set of records based on the first set of records and the second set of outcome records.

22. The article of manufacture of claim 16, wherein the at least one computer processor is further caused to operate so as to:
adjust the selected pairing strategy based on real-time conditions in the contact center system.
